(19) United States
(12) Patent Application Publication
(10) Pub. No.: US 2017/0318342 A1
(43) Pub. Date: Nov. 2, 2017

(54) CHANNEL SWITCHING METHOD AND DEVICE

(71) Applicant: SHENZHEN SKYWORTH-RGB ELECTRONIC CO., LTD., Shenzhen, Guangdong (CN)

(72) Inventor: Bei Shi, Shenzhen, Guangdong (CN)

(73) Assignees: SHENZHEN SKYWORTH-RGB ELECTRONIC CO., LTD., Shenzhen, Guangdong (CN); SHENZHEN SKYWORTH-RGB ELECTRONIC CO., LTD., Shenzhen, Guangdong (CN)

(21) Appl. No.: 15/319,382

(22) PCT Filed: Jan. 27, 2016
(86) PCT No.: PCT/CN2016/072358

§ 371 Date: Dec. 16, 2016

(30) Foreign Application Priority Data
Jan. 22, 2016 (CN) 201610045751.4

(51) Int. Cl. H04N 21/462; H04N 21/442; H04N 21/81; H04N 21/84

(52) U.S. Cl. CPC H04N 21/462; H04N 21/84; H04N 21/442; H04N 21/812

(57) ABSTRACT

The invention discloses a channel switching method, which includes the following steps: after a channel of a television is switched, a stream of a frequency point of a marked channel is monitored; whether a type of the stream is a program stream is determined, in which, the type of the stream includes the program stream and an advertisement stream; if yes, a current channel is switched to the marked channel. The invention also discloses a channel switching device. The present disclosure solves the problem that it is hard for user to switch back to the original channel on time to continue to watch the program after the original channel finishes the displaying of the advertisement, the punctuality of the channel switching is improved.

### FIELD OF THE DISCLOSURE

The present disclosure relates to the field of television technologies, and in particular, to a channel switching method and a device.

### BACKGROUND OF THE DISCLOSURE

With the smart television becomes more and more popular, it brings about new demands for the intelligent functions of the smart television. Currently, advertisements usually occurs in the playing process of the television program, and with the trend of the commercial purpose becomes more and more bigger, the advertising time becomes more and more long. When the current channel plays the advertisement, user normally switches to avoid the advertising time, however, after user switching the channel, any information of the original channel is lost, such that user cannot switch to the original channel in time to continue watching after the advertisements played on the original channel being finished, the channel cannot be automatically switched according to program information.

### SUMMARY OF THE DISCLOSURE

The present disclosure is to provide a channel switching method and a device, which aims to solve a problem that the channel cannot be automatically switched according to program information.

In order to realize the above aim, the present disclosure provides the channel switching method, which includes:

after a channel of a television is switched, monitoring a stream of a frequency point of a marked channel;

determining whether a type of the stream is a program stream, in which, the type of the stream includes the program stream and an advertisement stream; and

if yes, switching a current channel to the marked channel.

Optionally, after a channel of a television being switched, before monitoring a stream of a frequency point of a marked channel, the channel switching method further includes:

receiving a marking instruction triggered by a user based on the current channel;

when receiving the marking instruction, determining whether a channel corresponding to the marking instruction is the same with the marked channel;

if no, replacing the marked channel with the channel corresponding to the marking instruction.

Optionally, determining whether a type of the stream is a program stream includes the following steps:

testing whether a content descriptor exists in the stream;

when the content descriptor exists in the stream, determining whether the type of the stream is the program stream according to the content descriptor existed in the stream.

Optionally, determining whether a type of the stream is a program stream includes the following steps:

testing whether a content descriptor exists in the stream;

when the content descriptor exists in the stream, determining whether the type of the stream is the program stream according to the content descriptor existed in the stream.

Optionally, after testing whether a content descriptor exists in the stream, the channel switching method further comprises:

when the content descriptor does not exists in the stream, determining whether the type of the stream is the program stream according to character information of the stream.

Optionally, determining whether the type of the stream is the program stream according to character information of the stream comprises the following steps:

acquiring image character information and/or video character information;

determining whether the type of the stream is the program stream according to the image character information and/or the video character information.

Optionally, before monitoring a stream of a frequency point of a marked channel, the channel switching method further includes:

after the channel of the television is switched, determining whether the current channel is the same with the marked channel;

if no, executing monitoring the stream of the frequency point of the marked channel.

In addition, in order to realize the above aim, the present disclosure provides the channel switching device, which includes:

a monitoring module, which is used for monitoring a stream of a frequency point of a marked channel after a channel of a television is switched;

a determining module, which is used for determining whether a type of the stream being a program stream, in which, the type of the stream includes the program stream and an advertisement stream; and

a switching module, which is used for switching a current channel to the marked channel if the type of the stream is the program stream.

Optionally, the channel switching device further includes:

a receiving module, which is used for receiving a marking instruction triggered by a user based on the current channel;

the determining module is also used for determining whether a channel corresponding to the marking instruction is the same with the marked channel when receiving the marking instruction; and

an updating module, if the channel corresponding to the marking instruction is not the same with the marked channel, the updating module is used for replacing the marked channel with the channel corresponding to the marking instruction.

Optionally, the determining module comprises:

a testing unit, which is used for testing whether a content descriptor exists in the stream;

a determining unit, when the content descriptor exists in the stream, the determining unit is used for determining whether the type of the stream is the program stream according to the content descriptor existed in the stream.

Optionally, the determining module is also used for determining whether the type of the stream is the program stream according to character information of the stream when the content descriptor does not exists in the stream.

Optionally, the determining module includes:

an acquiring subunit, which is used for acquiring image character information and/or video character information;

a determining subunit, which is used for determining whether the type of the stream is the program stream according to the image character information and/or the video character information.

Optionally, the determining module is also used for determining whether the current channel is the same with the marked channel after the channel of the television is switched;

the monitoring module is also used for monitoring the stream of the frequency point of the marked channel.

The present disclosure monitors the stream of the frequency point of the marked channel after a channel of the television is switched in time or on time, such determining whether the type of the stream is the program stream, and when the type of the stream is the program stream, the returning instruction is triggered, the current channel is automatically switched to the marked channel according to the returning instruction, the problem of that the channel cannot be automatically switched according to the program information is effectively solved, the punctuality of the channel switching is improved.

### BRIEF DESCRIPTION OF THE DRAWINGS

FIG. 1 is a flow diagram of a channel switching method provided by a first exemplary embodiment of the present disclosure;

FIG. 2 is a detail flow diagram of the step of determining whether the type of the stream is the program stream of FIG. 1.

FIG. 3 is a detail flow diagram of the step of determining whether the type of the stream is the program stream according to the character information of the stream of FIG. 2.

FIG. 4 is a flow diagram of a channel switching method provided by a second exemplary embodiment of the present disclosure;

FIG. 5 is a flow diagram of a channel switching method provided by a third exemplary embodiment of the present disclosure;

FIG. 6 is a functional module diagram of a channel switching device provided by a first exemplary embodiment of the present disclosure.

FIG. 7 is a detail functional module diagram of a determining module of FIG. 6.

FIG. 8 is a functional module diagram of a channel switching device provided by a second exemplary embodiment of the present disclosure.

The realizing of the aim, functional characteristics, advantages of the present disclosure are further described in detail with reference to the accompanying drawings and the embodiments.

### DETAILED DESCRIPTION OF THE EMBODIMENTS

It is to be understood that, the described embodiments are only some exemplary embodiments of the present disclosure, and the present disclosure is not limited to such embodiments.

Based on the above problem, the present disclosure provides a channel switching method.

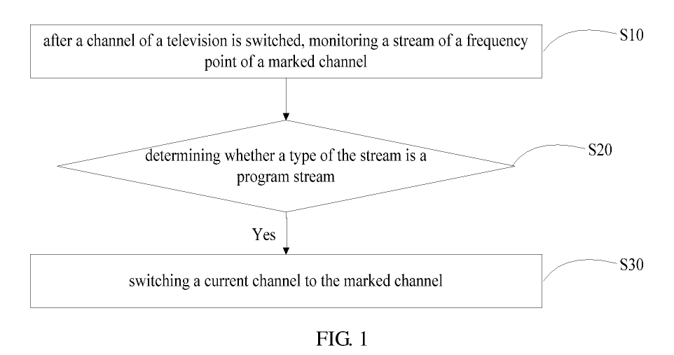

Referring to FIG. 1, FIG. 1 is a flow diagram of a channel switching method provided by a first exemplary embodiment of the present disclosure.

In the exemplary embodiment, the channel switching method includes:

Step S10, after a channel of a television is switched, monitoring a stream of a frequency point of a marked channel is monitored;

In the exemplary embodiment, an application scene is a television receiver having two tuners or a television receiver having one all channel tuner. When user watches a video program, if at this time, the program content displayed by the current channel is plugged advertisement, while user does not want to watch the advertisement, user will switch the current channel to other channel, however, at the same time, user wants to automatically switch to the current channel to watch the program of the current channel in time after the advertisement is over, so user should mark the current channel before the current channel is switched to other channel. In detail, when marking the current channel, the marking instruction for the current channel can be triggered by pressing a key of a remote control which has channel marking function, or the marking instruction for the current channel can be triggered by pressing a key on a button panel of the television receiver which has channel marking function. After the television receiver receives the marking instruction for the current channel triggered by user, the television receiver marks the current channel, and saves the marked channel, for automatically switching back to the marked channel later.

After the channel of the television is switched, the stream of the frequency point of the marked channel is marked. The channel switching can be switching one channel, or switching a plurality of channels. When the channel switching instruction is received, the stream of the frequency point of the marked channel is monitored, until the current channel is switched to the marked channel. In the exemplary embodiment, there are two methods for monitoring the stream of the frequency point of the marked channel. 1) if the television receiver has two tuners, one tuner of the television receiver takes the frequency point of the marked channel as the monitoring frequency point, the other tuner is responsible for receiving the stream of the frequency point of the channel after switching, and treating the received stream by a serious of operation, such as demultiplexing and decoding the received stream, and so on, finally, the treated stream is transmitted to a displaying port of the television, for the television displaying the television program corresponding to the stream. 2) if the tuner of the television receiver is the full channel tuner, the full channel tuner monitors the stream of the frequency point of the marked channel in time or on time, at the same time, the stream of the frequency point of the channel after switching is received, and the received stream is treated by a serious of operation, such as demultiplexing and decoding the received stream, and so on, finally, he treated stream is transmitted to a displaying port of the television, for the television displaying the television program corresponding to the stream.

Step S20, determining whether a type of the stream is a program stream, in which, the type of the stream includes the program stream and an advertisement stream;

The stream of the frequency point of marked channel is monitored in time or on time, for determining whether the type of the stream is the program stream. In the exemplary embodiment, the type of the stream includes the program stream and the advertisement stream. The program stream can be referred to that video content corresponding to the stream is video program, the video program includes a film, a teleplay, a variety show, and so on, the advertisement stream can be referred to that video content corresponding to the stream is plugged advertisement.

Step S30, if yes, switching a current channel to the marked channel.

The stream of the frequency point of marked channel is monitored in time or on time, when the type of the stream of the frequency point corresponding to the marked channel is determined as the program stream, the current channel is switched back to the marked channel. In detail, when the stream is monitored to be the program stream, one channel returning instruction is triggered, after the television receiver receives the channel returning instruction, the current channel is switched back to the marked channel. Such as, in an exemplary embodiment, when the channel returning instruction is received, after the received stream of the marked and monitored channel is treated by a serious of operation, such as demultiplexing and decoding the received stream, and so on, finally, the treated stream is transmitted to the displaying port of the television, for the television displaying the television program corresponding to the stream, at the same time the other tuner stops working, so that the current channel is switched back to marked channel; in another exemplary embodiment of the present disclosure, when the channel returning instruction is received, the stream at the displaying port of the television currently transmitted from the full channel tuner can be directly changed to the stream of the frequency point corresponding to the marked channel, so that the television displays the television program corresponding to the stream, such that the current channel is switched back to the marked channel is realized.

The present disclosure monitors the stream of the frequency point of the marked channel after a channel of the television is switched in time or on time, such determining whether the type of the stream is the program stream, and when the type of the stream is the program stream, the returning instruction is triggered, the current channel is automatically switched to the marked channel according to the returning instruction, the problem of that the channel cannot be automatically switched according to the program information is effectively solved, the punctuality of the channel switching is improved, and user has a better experience.

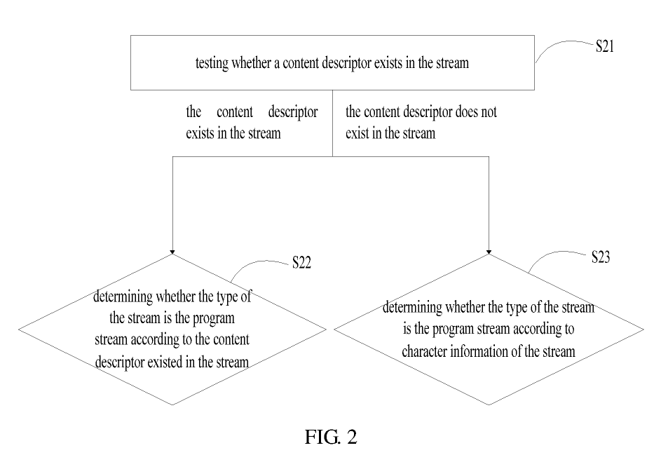

Furthermore, the present disclosure provides a channel switching method according to a second exemplary embodiment based on the first exemplary embodiment, referring to FIG. 2, in the second exemplary embodiment, the step S20 includes:

Step S21, testing whether a content descriptor exists in the stream;

When whether the type of the stream is the program stream is determined, it can be determined by testing whether the content descriptor exists in the stream. In detail, the stream of the frequency point of the marked channel is demultiplexed, an event information table in the demultiplexed stream is acquired. The event information table provides event information included in each business according to time sequence, is further description of a program, includes information related with the event or the program, such as, a name of the event or the program, a starting time, a lasting time, a displaying state, whether encryption, a type of the basic stream, a type of the program, an age limit level, and so on, can be divided into resent, following, and schedule, and respectively includes a current event and information of the next event and information of all the event arranged in a long time period. After acquiring the event information table, whether the content descriptor exists in the event information table is tested, the content descriptor provides content information of the program, which includes the type of the program, the starting time and the lasting time.

Step S22, when the content descriptor exists in the stream, determining whether the type of the stream is the program stream according to the content descriptor existed in the stream.

When the content descriptor exists in the stream is tested, as the description of the program type exists in the content descriptor, so whether the type of the stream is the program stream or the advertisement stream is directly determined according to the description of the program type in the content descriptor.

Step S23, when the content descriptor does not exists in the stream, determining whether the type of the stream is the program stream according to character information of the stream.

When the content descriptor does not exists in the stream is tested, whether the type of the stream is the program stream is determined according to character information of the stream, the character information of the stream includes image character information and video character information.

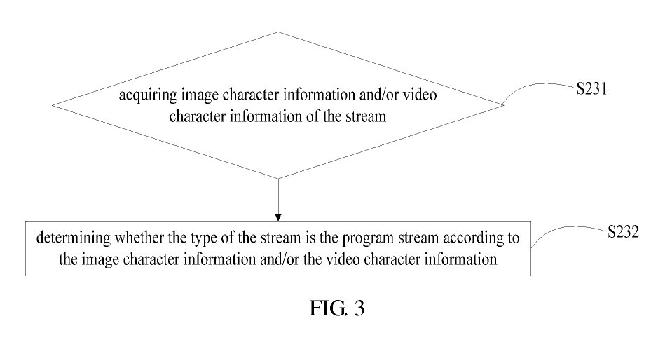

In detail, referring to FIG. 3, determining whether the type of the stream is the program stream according to the character information of the stream includes the following steps:

Step S231, acquiring image character information and/or video character information of the stream;

Step S232, determining whether the type of the stream is the program stream according to the image character information and/or the video character information.

In the exemplary embodiment, the stream includes the image character information and the video character information. The image character information of the stream can be the image character information of the video stream, the image character information includes a relation between adjacent frames, advertisement trademark information and a switching frequency of the video pictures. In detail, adjacent image frames in the video stream can be analyzed to acquire correlations between adjacent frames, for determining continuity of the current video picture, the greater correlations exists between adjacent frames, the video pictures are much more continuity continuous, the continuity of the pictures of the advertisement stream is normally lower than the continuity of the pictures of the program stream, so that whether the stream is the program stream or the advertisement stream is determined according to the continuity of adjacent frames, if the continuity of adjacent frames is larger than or equal to a preset value, the stream is determined to be the program stream, if the continuity of adjacent frames is lower than the preset value, the stream is determined to be the advertisement stream; characters in the image frame of the video stream can be extracted, the advertisement trademark information in the image frame can be extracted, it is to be noted that, the system presets a variety of the advertisement trademark information, if the advertisement trademark information cannot be extracted from all of the image frames, it is determine that the stream is the program stream, if the advertisement trademark information can be extracted from the image frame, the stream may be the program stream or advertisement; a picture switching frequency in the video stream can be analyzed to acquire the picture switching frequency in the video frequency, the picture switching frequency of the advertisement stream is normally higher than the picture switching frequency of the program stream, so whether the stream is the program stream or the advertisement stream is determined according to the picture switching frequency, if the picture switching frequency is lower than a preset value, the stream can be determined to be the program stream, if the picture switching frequency is higher than or equal to the preset value, the stream is determined to be the advertisement stream. After the type of the stream is determined by the above method, whether the stream is the program stream or the advertisement stream is determined according to different weights of the methods. The video character information of the stream can be audio character information of the video stream, the video character can be spectrum character of the video stream, the acquired spectrum character of the stream can be matched with a preset spectrum character of advertisement video stream for recognizing whether the video stream is the program stream or the advertisement stream by presetting spectrum characters of a variety of advertisement's video stream. Furthermore, in order to judge the type of the stream much more accuracy, whether the type of the stream is the program stream is determined with the combination of the acquired image character information and the video character information, after the image character information and the video character information are acquired.

The present disclosure tests whether content descriptor exists in the stream, when the content descriptor exists in the stream, whether the type of the stream is the program stream is determined according to the content in the content descriptor, when the content descriptor does not exists in the stream, whether the type of the stream is the program stream is determined according to the character information of the stream, so that the type of the stream is accurately recognized, it provides a base for switching the channel back to the marked channel in time.

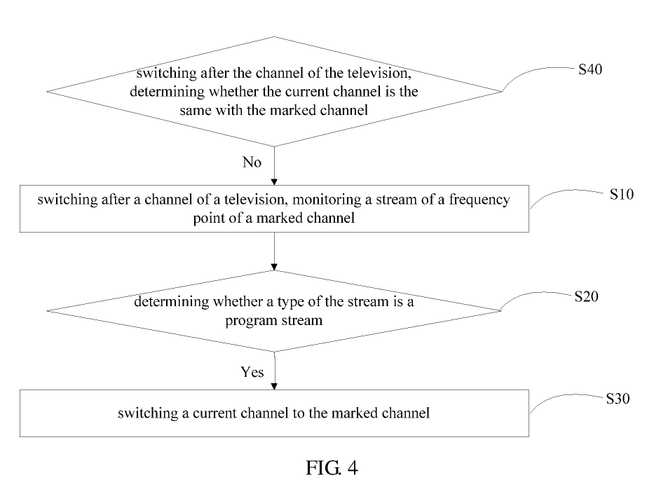

Furthermore, the present disclosure provides a channel switching method according to a third exemplary embodiment based on the first exemplary embodiment or the second exemplary embodiment, referring to FIG. 4, before monitoring the stream of the frequency point of the marked channel, the channel switching method further includes:

Step S40, after the channel of the television is switched, determining whether the current channel is the same with the marked channel is determined;

If the current channel is the different from the marked channel, go to step S10, that is, the stream of the frequency point of the marked channel is monitored.

After the channel of the television is switched, user may switch several channels and then switch back to the marked channel, at this time, in order to save energy, it should stop monitoring the stream of the frequency point of the marked channel, so in order to save energy, after the channel of the television is switched, whether the current channel is the same with the marked channel is determined, when the switched channel is the same with the marked channel, it should directly stop monitoring the stream of the frequency point of the marked channel, when the switched channel is different from the marked channel, the stream of the frequency point of the marked channel is monitored.

The present disclosure compares the switched channel with the marked channel, when the switched channel is the same with the marked channel, it should stop monitoring the stream of the frequency point of the marked channel to reduce the consumption of the device.

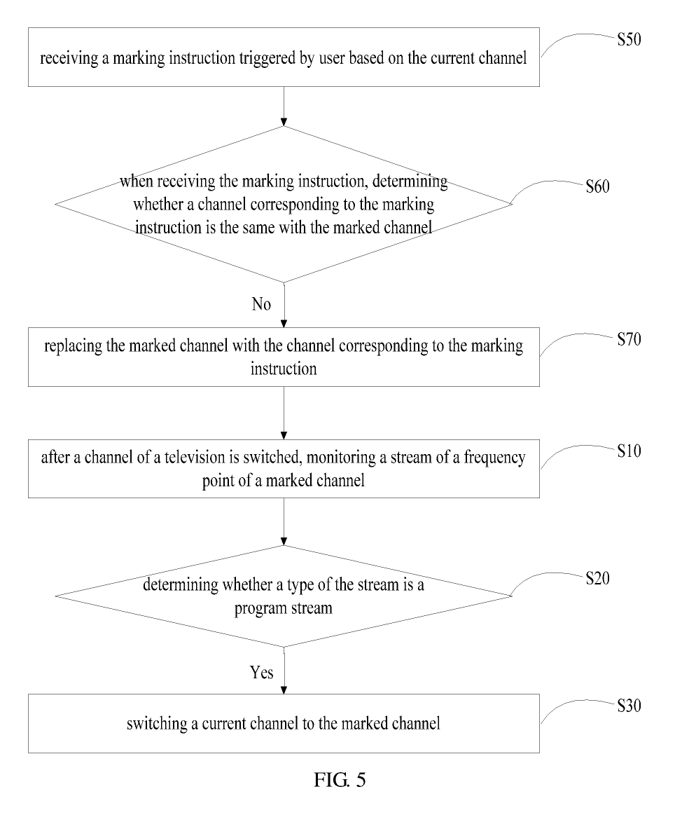

Furthermore, the present disclosure provides a channel switching method according to a fourth exemplary embodiment based on any of above exemplary embodiments, referring to FIG. 5, before step S10, the channel switching method further includes:

Step S50, receiving a marking instruction triggered by user based on the current channel;

Step S60, when receiving the marking instruction, determining whether a channel corresponding to the marking instruction is the same with the marked channel;

Step S70, if no, replacing the marked channel with the channel corresponding to the marking instruction.

When after user switches the marked channel to other channel, user may prefer to watch the video program of the current channel, user will mark the current channel again, when the television receiver receives the marking instruction, the television receiver judges whether the channel corresponding to the received marking instruction is the same with the marked channel to ensure whether it needs to update the marked channel, if no, the marked channel is replaced with the channel corresponding to the marking instruction, and the television saves the channel corresponding to the marking instruction, when the new marked channel displays advertisement, user switches the new marked channel to other channel, when automatically returning back to the marked channel later, the current switch would be automatically switched back to the new marked channel, not the previous marked channel. Such as, the previous marked channel can be channel 1, the switched channel can be channel 2, the switched channel can be the new marked channel, a channel switched again can be channel 3, if receiving the channel returning instruction, the current channel 3 is automatically switched back to the new marked channel 2, not the channel 1.

The exemplary embodiment marks a new channel after marking one channel, the marked channel is replaced with the new marked channel, the updated marked channel can be taken as a new marked channel, so that the current channel can be automatically return back to the new marked channel, a watching comfort level of the user can be improved.

The present disclosure further provides a channel switching device.

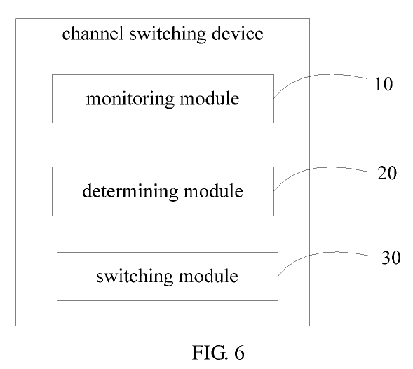

Referring to FIG. 6, FIG. 6 is a functional module diagram of a channel switching device provided by a first exemplary embodiment of the present disclosure.

In the exemplary embodiment, the channel switching device includes: a monitoring module 10, a determining module 20 and a switching module 30.

The receiving module 10 is used for monitoring a stream of a frequency point of a marked channel after a channel of a television is switched;

In the exemplary embodiment, an application scene is a television receiver having two tuners or a television receiver having one all channel tuner. When user watches a video program, if at this time, the program content displayed by the current channel is plugged advertisement, while user does not want to watch the advertisement, user will switch the current channel to other channel, however, at the same time, user wants to automatically switch to the current channel to watch the program of the current channel in time after the advertisement is over, so user should mark the current channel before the current channel is switched to other channel. In detail, when marking the current channel, the marking instruction for the current channel can be triggered by pressing a key of a remote control which has channel marking function, or the marking instruction for the current channel can be triggered by pressing a key on a button panel of the television receiver which has channel marking function. After the television receiver receives the marking instruction for the current channel triggered by user, the television receiver marks the current channel, and saves the marked channel, for automatically switching back to the marked channel later.

After the channel of the television is switched, the stream of the frequency point of the marked channel is marked. The channel switching can be switching one channel, or switching a plurality of channels. When the channel switching instruction is received, the stream of the frequency point of the marked channel is monitored, until the current channel is switched to the marked channel. In the exemplary embodiment, there are two methods for monitoring the stream of the frequency point of the marked channel. 1) if the television receiver has two tuners, one tuner of the television receiver takes the frequency point of the marked channel as the monitoring frequency point, the other tuner is responsible for receiving the stream of the frequency point of the channel after switching, and treating the received stream by a serious of operation, such as demultiplexing and decoding the received stream, and so on, finally, the treated stream is transmitted to a displaying port of the television, for the television displaying the television program corresponding to the stream. 2) if the tuner of the television receiver is the full channel tuner, the full channel tuner monitors the stream of the frequency point of the marked channel in time or on time, at the same time, the stream of the frequency point of the channel after switching is received, and the received stream is treated by a serious of operation, such as demultiplexing and decoding the received stream, and so on, finally, he treated stream is transmitted to a displaying port of the television, for the television displaying the television program corresponding to the stream.

The determining module 20 is also used for determining whether a type of the stream being a program stream, in which, the type of the stream comprising the program stream and an advertisement stream;

The stream of the frequency point of marked channel is monitored in time or on time, for determining whether the type of the stream is the program stream. In the exemplary embodiment, the type of the stream includes the program stream and the advertisement stream. The program stream can be referred to that video content corresponding to the stream is video program, the video program includes a film, a teleplay, a variety show, and so on, the advertisement stream can be referred to that video content corresponding to the stream is plugged advertisement.

Furthermore, the determining module 20 can be also used for determining whether the current channel is the same with the marked channel after the channel of the television is switched;

The monitoring module is also used for monitoring the stream of the frequency point of the marked channel.

After the channel of the television is switched, user may switch several channels and then switch back to the marked channel, at this time, in order to save energy, it should stop monitoring the stream of the frequency point of the marked channel, so in order to save energy, after the channel of the television is switched, whether the current channel is the same with the marked channel is determined, when the switched channel is the same with the marked channel, it should directly stop monitoring the stream of the frequency point of the marked channel, when the switched channel is different from the marked channel, the stream of the frequency point of the marked channel is monitored.

The switching module 30 is used for switching a current channel back to the marked channel if the type of the stream is the program stream.

The stream of the frequency point of marked channel is monitored in time or on time, when the type of the stream of the frequency point corresponding to the marked channel is determined as the program stream, the current channel is switched back to the marked channel. In detail, when the stream is monitored to be the program stream, one channel returning instruction is triggered, after the television receiver receives the channel returning instruction, the current channel is switched back to the marked channel. Such as, in an exemplary embodiment, when the channel returning instruction is received, after the received stream of the marked and monitored channel is treated by a serious of operation, such as demultiplexing and decoding the received stream, and so on, finally, the treated stream is transmitted to the displaying port of the television, for the television displaying the television program corresponding to the stream, at the same time the other tuner stops working, so that the current channel is switched back to marked channel; in another exemplary embodiment of the present disclosure, when the channel returning instruction is received, the stream at the displaying port of the television currently transmitted from the full channel tuner can be directly changed to the stream of the frequency point corresponding to the marked channel, so that the television displays the television program corresponding to the stream, such that the current channel is switched back to the marked channel is realized.

The present disclosure monitors the stream of the frequency point of the marked channel after a channel of the television is switched in time or on time, such determining whether the type of the stream is the program stream, and when the type of the stream is the program stream, the returning instruction is triggered, the current channel is automatically switched to the marked channel according to the returning instruction, the problem of that the channel cannot be automatically switched according to the program information is effectively solved, the punctuality of the channel switching is improved, and user has a better experience.

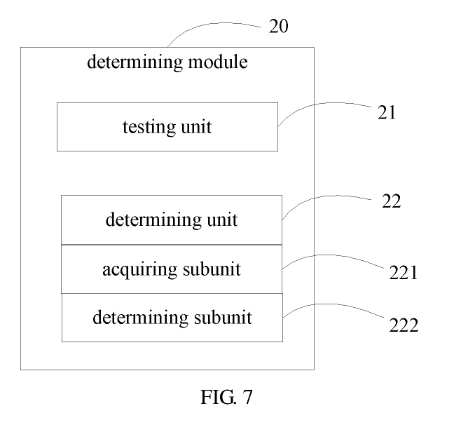

Furthermore, the present disclosure provides a channel switching device according to a second exemplary embodiment based on the first exemplary embodiment, referring to FIG. 7, in the exemplary embodiment, the determining module 20 includes: a testing unit 21 and a determining unit 22.

The testing unit 21 is used for testing whether a content descriptor exists in the stream;

When whether the type of the stream is the program stream is determined, it can be determined by testing whether the content descriptor exists in the stream. In detail, the stream of the frequency point of the marked channel is demultiplexed, an event information table in the demultiplexed stream is acquired. The event information table provides event information included in each business according to time sequence, is further description of a program, includes information related with the event or the program, such as, a name of the event or the program, a starting time, a lasting time, a displaying state, whether encryption, a type of the basic stream, a type of the program, an age limit level, and so on, can be divided into resent, following, and schedule, and respectively includes a current event and information of the next event and information of all the event arranged in a long time period. After acquiring the event information table, whether the content descriptor exists in the event information table is tested, the content descriptor provides content information of the program, which includes the type of the program, the starting time and the lasting time.

The determining unit 22 is used for determining whether the type of the stream is the program stream according to the content descriptor existed in the stream when the content descriptor exists in the stream;

When the content descriptor exists in the stream is tested, as the description of the program type exists in the content descriptor, so whether the type of the stream is the program stream or the advertisement stream is directly determined according to the description of the program type in the content descriptor.

When the content descriptor does not exist in the stream is tested, the determining unit 22 is used for determining whether the type of the stream is the program stream according to character information of the stream.

When the content descriptor does not exists in the stream is tested, whether the type of the stream is the program stream is determined according to character information of the stream, the character information of the stream includes image character information and video character information. In detail, referring to FIG. 7, the determining unit 22 includes an acquiring subunit 221 and a determining subunit 222.

The acquiring subunit 221 is used for acquiring image character information and/or video character information of the stream;

the determining subunit 222 is used for determining whether the type of the stream is the program stream according to the image character information and/or the video character information.

In the exemplary embodiment, the stream includes the image character information and the video character information. The image character information of the stream can be the image character information of the video stream, the image character information includes a relation between adjacent frames, advertisement trademark information and a switching frequency of the video pictures. In detail, adjacent image frames in the video stream can be analyzed to acquire correlations between adjacent frames, for determining continuity of the current video picture, the greater correlations exists between adjacent frames, the video pictures are much more continuity continuous, the continuity of the pictures of the advertisement stream is normally lower than the continuity of the pictures of the program stream, so that whether the stream is the program stream or the advertisement stream is determined according to the continuity of adjacent frames, if the continuity of adjacent frames is larger than or equal to a preset value, the stream is determined to be the program stream, if the continuity of adjacent frames is lower than the preset value, the stream is determined to be the advertisement stream; characters in the image frame of the video stream can be extracted, the advertisement trademark information in the image frame can be extracted, it is to be noted that, the system presets a variety of the advertisement trademark information, if the advertisement trademark information cannot be extracted from all of the image frames, it is determine that the stream is the program stream, if the advertisement trademark information can be extracted from the image frame, the stream may be the program stream or advertisement; a picture switching frequency in the video stream can be analyzed to acquire the picture switching frequency in the video frequency, the picture switching frequency of the advertisement stream is normally higher than the picture switching frequency of the program stream, so whether the stream is the program stream or the advertisement stream is determined according to the picture switching frequency, if the picture switching frequency is lower than a preset value, the stream can be determined to be the program stream, if the picture switching frequency is higher than or equal to the preset value, the stream is determined to be the advertisement stream. After the type of the stream is determined by the above method, whether the stream is the program stream or the advertisement stream is determined according to different weights of the methods. The video character information of the stream can be audio character information of the video stream, the video character can be spectrum character of the video stream, the acquired spectrum character of the stream can be matched with a preset spectrum character of advertisement video stream for recognizing whether the video stream is the program stream or the advertisement stream by presetting spectrum characters of a variety of advertisement's video stream. Furthermore, in order to judge the type of the stream much more accuracy, whether the type of the stream is the program stream is determined with the combination of the acquired image character information and the video character information, after the image character information and the video character information are acquired.

The present disclosure tests whether content descriptor exists in the stream, when the content descriptor exists in the stream, whether the type of the stream is the program stream is determined according to the content in the content descriptor, when the content descriptor does not exists in the stream, whether the type of the stream is the program stream is determined according to the character information of the stream, so that the type of the stream is accurately recognized, it provides a base for switching the channel back to the marked channel in time.

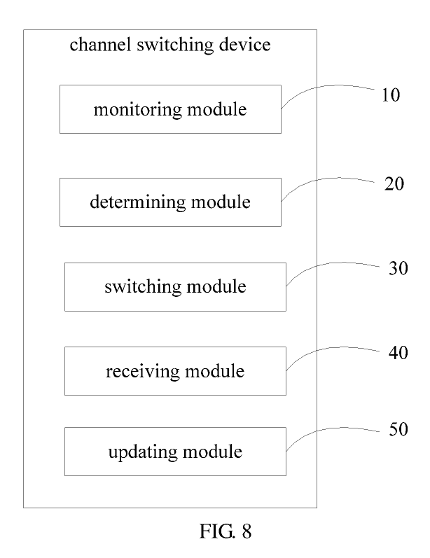

Furthermore, the present disclosure provides a channel switching device according to a third exemplary embodiment based on any one of the above exemplary embodiments, referring to FIG. 8, in the exemplary embodiment, the channel switching device further includes: a receiving module 40 and an updating module 50.

The receiving module 40 is used for receiving a marking instruction triggered by a user based on the current channel;

the determining module 20 is also used for determining whether a channel corresponding to the marking instruction is the same with the marked channel when receiving the marking instruction;

if the channel corresponding to the marking instruction is not the same with the marked channel, the updating module 50 is used for replacing the marked channel with the channel corresponding to the marking instruction.

When after user switches the marked channel to other channel, user may prefer to watch the video program of the current channel, user will mark the current channel again, when the television receiver receives the marking instruction, the television receiver judges whether the channel corresponding to the received marking instruction is the same with the marked channel to ensure whether it needs to update the marked channel, if no, the marked channel is replaced with the channel corresponding to the marking instruction, and the television saves the channel corresponding to the marking instruction, when the new marked channel displays advertisement, user switches the new marked channel to other channel, when automatically returning back to the marked channel later, the current switch would be automatically switched back to the new marked channel, not the previous marked channel. Such as, the previous marked channel can be channel 1, the switched channel can be channel 2, the switched channel can be the new marked channel, a channel switched again can be channel 3, if receiving the channel returning instruction, the current channel 3 is automatically switched back to the new marked channel 2, not the channel 1.

The exemplary embodiment marks a new channel after marking one channel, the marked channel is replaced with the new marked channel, the updated marked channel can be taken as a new marked channel, so that the current channel can be automatically return back to the new marked channel, a watching comfort level of the user can be improved.

The serial numbers of the above exemplary embodiment of the present disclosure are only used for describing, not presenting the performances of the exemplary embodiments. Through the describing of the exemplary embodiments, the ordinary skill in the art can clearly know that the exemplary embodiment method can be achieved by software and a necessary general hardware platform, of course, by hardware, however in most cases, the former is a better exemplary embodiment. Based on the understanding, the technical proposal of the present disclosure essentially, or parts contributing to the existing technology, can be presented through software product, the computer software product is stored in a storage medium (such as ROM/RAM, a diskette, a light disk), includes a plurality of instructions which can be used for making a terminal device (the terminal device can be a phone, a computer, a server, an air conditioner, or a network device, and so on) to execute the methods of the exemplary embodiments of the present disclosure.

The embodiments above are preferably embodiments of the present disclosure, and the present disclosure is not limited to such embodiments, equivalent structure conversion based on the specification and the drawing of the present disclosure, or directly or indirectly used in other related technical field, both similarly within the protection scope of the present disclosure.

What is claimed is:

1. A channel switching method, comprising the following steps:
after a channel of a television being switched, monitoring a stream of a frequency point of a marked channel;
determining whether a type of the stream being a program stream, in which, the type of the stream comprising the program stream and an advertisement stream; and
if yes, switching a current channel to the marked channel.

2. The channel switching method according to claim 1, wherein after a channel of a television being switched, before monitoring a stream of a frequency point of a marked channel, the channel switching method further comprises:
receiving a marking instruction triggered by a user based on the current channel;
when receiving the marking instruction, determining whether a channel corresponding to the marking instruction is the same with the marked channel;
if no, replacing the marked channel with the channel corresponding to the marking instruction.

3. The channel switching method according to claim 1, wherein determining whether a type of the stream is a program stream comprises the following steps:
testing whether a content descriptor exists in the stream;
when the content descriptor exists in the stream, determining whether the type of the stream is the program stream according to the content descriptor existed in the stream.

4. The channel switching method according to claim 3, wherein after a channel of a television being switched, before monitoring a stream of a frequency point of a marked channel, the channel switching method further comprises:
receiving a marking instruction triggered by a user based on the current channel;
when receiving the marking instruction, determining whether a channel corresponding to the marking instruction is the same with the marked channel;
if no, replacing the marked channel with the channel corresponding to the marking instruction.

5. The channel switching method according to claim 3, wherein after testing whether a content descriptor exists in the stream, the channel switching method further comprises:
when the content descriptor does not exists in the stream, determining whether the type of the stream is the program stream according to character information of the stream.

6. The channel switching method according to claim 5, wherein after a channel of a television being switched, before monitoring a stream of a frequency point of a marked channel, the channel switching method further comprises:
receiving a marking instruction triggered by a user based on the current channel;
when receiving the marking instruction, determining whether a channel corresponding to the marking instruction is the same with the marked channel;
if no, replacing the marked channel with the channel corresponding to the marking instruction.

7. The channel switching method according to claim 5, wherein determining whether the type of the stream is the program stream according to character information of the stream comprises the following steps:
acquiring image character information and/or video character information;
determining whether the type of the stream is the program stream according to the image character information and/or the video character information.

8. The channel switching method according to claim 7, wherein after a channel of a television being switched, before monitoring a stream of a frequency point of a marked channel, the channel switching method further comprises:
receiving a marking instruction triggered by a user based on the current channel;
when receiving the marking instruction, determining whether a channel corresponding to the marking instruction is the same with the marked channel;
if no, replacing the marked channel with the channel corresponding to the marking instruction.

9. The channel switching method according to claim 1, wherein before monitoring a stream of a frequency point of a marked channel, the channel switching method further comprises:
after the channel of the television is switched, determining whether the current channel is the same with the marked channel;
if no, executing monitoring the stream of the frequency point of the marked channel.

10. The channel switching method according to claim 9, wherein after a channel of a television being switched, before monitoring a stream of a frequency point of a marked channel, the channel switching method further comprises:
receiving a marking instruction triggered by a user based on the current channel;
when receiving the marking instruction, determining whether a channel corresponding to the marking instruction is the same with the marked channel;
if no, replacing the marked channel with the channel corresponding to the marking instruction.

11. A channel switching device, comprising:
a monitoring module, which being used for monitoring a stream of a frequency point of a marked channel after a channel of a television being switched;
a determining module, which being used for determining whether a type of the stream being a program stream, in which, the type of the stream comprising the program stream and an advertisement stream; and
a switching module, which being used for switching a current channel to the marked channel if the type of the stream being the program stream.

12. The channel switching device according to claim 11, wherein the channel switching device further comprises:
a receiving module, which is used for receiving a marking instruction triggered by a user based on the current channel;
the determining module is also used for determining whether a channel corresponding to the marking instruction is the same with the marked channel when receiving the marking instruction; and
an updating module, if the channel corresponding to the marking instruction is not the same with the marked channel, the updating module is used for replacing the marked channel with the channel corresponding to the marking instruction.

13. The channel switching device according to claim 11, wherein the determining module comprises:
a testing unit, which is used for testing whether a content descriptor exists in the stream;
a determining unit, when the content descriptor exists in the stream, the determining unit is used for determining whether the type of the stream is the program stream according to the content descriptor existed in the stream.

14. The channel switching device according to claim 13, wherein the channel switching device further comprises:
a receiving module, which is used for receiving a marking instruction triggered by a user based on the current channel;
the determining module is also used for determining whether a channel corresponding to the marking instruction is the same with the marked channel when receiving the marking instruction; and
an updating module, if the channel corresponding to the marking instruction is not the same with the marked channel, the updating module is used for replacing the marked channel with the channel corresponding to the marking instruction.

15. The channel switching device according to claim 13, wherein the determining module, is also used for determining whether the type of the stream is the program stream according to character information of the stream when the content descriptor does not exists in the stream.

16. The channel switching device according to claim 15, wherein the channel switching device further comprises:
a receiving module, which is used for receiving a marking instruction triggered by a user based on the current channel;
the determining module is also used for determining whether a channel corresponding to the marking instruction is the same with the marked channel when receiving the marking instruction; and
an updating module, if the channel corresponding to the marking instruction is not the same with the marked channel, the updating module is used for replacing the marked channel with the channel corresponding to the marking instruction.

17. The channel switching device according to claim 15, wherein the determining module comprises:
an acquiring subunit, which is used for acquiring image character information and/or video character information;
a determining subunit, which is used for determining whether the type of the stream is the program stream according to the image character information and/or the video character information.

18. The channel switching device according to claim 17, wherein the channel switching device further comprises:
a receiving module, which is used for receiving a marking instruction triggered by a user based on the current channel;
the determining module is also used for determining whether a channel corresponding to the marking instruction is the same with the marked channel when receiving the marking instruction; and
an updating module, if the channel corresponding to the marking instruction is not the same with the marked channel, the updating module is used for replacing the marked channel with the channel corresponding to the marking instruction.

19. The channel switching device according to claim 11, wherein the determining module is also used for determining whether the current channel is the same with the marked channel after the channel of the television is switched;
the monitoring module is also used for monitoring the stream of the frequency point of the marked channel.

20. The channel switching device according to claim 19, wherein the channel switching device further comprises:
a receiving module, which is used for receiving a marking instruction triggered by a user based on the current channel;
the determining module is also used for determining whether a channel corresponding to the marking instruction is the same with the marked channel when receiving the marking instruction; and
an updating module, if the channel corresponding to the marking instruction is not the same with the marked channel, the updating module is used for replacing the marked channel with the channel corresponding to the marking instruction.
